(19) United States
(12) Patent Application Publication
(10) Pub. No.: US 2010/0316548 A1
(43) Pub. Date: Dec. 16, 2010

(54) METHODS AND SYSTEMS FOR EFFICIENT NEUTRALIZATION OF ACID GASES

(76) Inventors: Patrick J. Bullen, Elmhurst, IL (US); David J. Shecterle, Arlington Heights, IL (US); Jocelyn C. Daguio, Chicago, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/482,114

(22) Filed: Jun. 10, 2009

(51) Int. Cl. B01D 53/68; B01D 53/40; B01D 53/52; B01D 53/50

(52) U.S. Cl. 423/234; 423/210; 423/220; 423/240 R; 423/241; 423/242.1

(57) ABSTRACT

Methods and apparatuses are disclosed for the continuous treatment of gas streams contaminated with one or more acid gases, for example HCl, H₂S, SO₂, SO₃, and/or Cl₂. At least primary and secondary neutralization zones are utilized, with the secondary neutralization zone being fed by a portion of the gas stream that is used to carry out essentially complete neutralization of a neutralization solution, such as aqueous sodium hydroxide, prior to its disposal (e.g., via biological treatment). The flow of this portion of the gas stream may be regulated by periodically or continuously monitoring the concentration or pH of the spent neutralization solution exiting the secondary neutralization zone. Suitable gas streams that can be treated include effluent gases comprising hydrogen chloride from hydrocarbon conversion processes, particularly paraffin isomerization processes, utilizing a chloriding agent as a catalyst promoter.

### FIELD OF THE INVENTION

The present invention relates to the treatment of gas streams comprising an acid gas and more particularly to treatment methods and apparatuses in which a neutralization solution such as aqueous sodium hydroxide is utilized efficiently through contact with separate portions of a gas stream in primary and secondary neutralization zones.

### DESCRIPTION OF RELATED ART

The treatment of numerous industrial gas streams is required to remove acid gas contaminants that would otherwise be released into the environment as harmful and polluting emissions. Acid gases that must be removed include the hydrogen halides (HCl, HBr, HF, and HI), hydrogen sulfide (H₂S), sulfur oxides (SO₂ and SO₃), and chlorine (Cl₂). These acid gases originate from a wide variety of operations, for example as combustion (oxidation) products, chemical reaction byproducts, and process additive conversion products.

For example, a number of hydrocarbon conversion processes in oil refining and petrochemical manufacture rely on the use of catalysts that require the addition of chlorine or chloride compounds for various purposes. These include the promotion or enhancement of catalytic activity, by introducing a chloride compound into the reaction zone to maintain a desired level of chloride deposited on the catalyst. Particular catalytic hydrocarbon conversion processes that utilize the addition of a chloride promoter are those involving the isomerization of normal paraffins. Processes for the isomerization of hydrocarbon feeds containing primarily normal butane, or alternatively containing primarily normal pentane and normal hexane, are described in U.S. Pat. No. 4,877,919 and U.S. Pat. No. 5,705,730, respectively. Other hydrocarbon conversion processes use chlorine for redistributing catalytic metal that becomes agglomerated over one or more cycles of reaction and regeneration of the catalyst. A notable example is in the reforming of naphtha boiling range hydrocarbons to improve octane number, as described in U.S. Pat. No. 4,243,515 and other patents. The regeneration of catalysts in such reforming processes normally includes an oxychlorination step for active metal redistribution.

In addition to isomerization and reforming, other refining processes that similarly use chloride compounds and must therefore avoid the excessive release of gaseous HCl include dehydrogenation, alkylation, and transalkylation, all of which are well known in the art. Non-catalytic conversion processes that operate without hydrogen addition, such as the production of ethylene via steam cracking, can also produce gaseous effluent streams containing one or more acid gases, for example H₂S.

A number of hydrocarbon conversion processes, particularly those using platinum catalysts, therefore share the feature of contacting the catalyst at some stage, either during reaction or regeneration, with one or more chloride compounds (or chloriding agents). These compounds may be chemically or physically sorbed on the catalyst as chloride or may remain dispersed in a stream that contacts the catalyst. Ultimately, flue or vent gas streams in many of these processes contain the chloride compounds, or their reaction products, in varying concentrations. A chloride compound reaction product of significant concern in hydrocarbon processing industries is hydrogen chloride (HCl), which forms readily in reaction environments such as those encountered in processes discussed above for paraffin isomerization, which utilize a noble metal catalyst and added hydrogen.

Several methods are known for minimizing the release of HCl and other acid gases contained in flue or vent gas streams from these and other processes. Environmental concerns associated with the release of acid gases are often mitigated, for example, by scrubbing the acid gas-containing gas stream with a basic neutralization solution that removes the acid gas and neutralizes the solution (e.g., by the formation of a salt solution). Due to its availability, an aqueous sodium hydroxide or caustic solution is frequently used for this purpose. To ensure that the environment of a scrubber remains basic and non-corrosive, an excess of caustic or other aqueous neutralization solution (e.g., aqueous potassium hydroxide) is introduced batchwise to a scrubber vessel or column, typically with the excess being on the order of about 20% of the quantity required for complete neutralization. Attempts to improve neutralization solution utilization and decrease this excess amount have been complicated by safety issues, due to the increased possibility of rendering the spent solution acidic (e.g., in the case of an upset condition) as well as performance issues, due to the reduced neutralizing driving force as total consumption of the solution is approached.

The periodic, batchwise replacement of the scrubber inventory therefore continues to be a common practice, despite the significant costs, not only for supplying fresh solution, but also for disposing of the spent or used solution. In particular, the excess portion of the solution that is not used in the neutralization of acid gases must be more completely neutralized (e.g., to a pH of about 9 or less), prior to disposal in biological treatment facilities. Moreover, the batch replacement method results in inherent safety concerns associated with the handling of basic solutions such as aqueous sodium hydroxide.

Methods for the effective neutralization of acid gases in gas streams, with the efficient utilization of neutralization solution, are continually being sought.

### SUMMARY OF THE INVENTION

The present invention is associated with the discovery of methods and apparatuses for treating gas streams contaminated with one or more acid gases, for example HCl, H₂S, SO₂, SO₃, and/or Cl₂. Advantageously, complete or nearly complete consumption of the neutralization solution is possible with not only continuous treatment of the gas stream, but also continuous makeup neutralization solution addition and spent neutralization solution withdrawal, according to embodiments of the invention described herein. Several drawbacks of conventional, batch scrubbing processes associated with the safety of periodic fresh solution replacement/handling and cost of disposing of excess solution, as discussed above, may be avoided. In fact, according to specific embodiments of the invention, effective acid gas removal is achieved while providing a spent neutralization solution having a pH value (e.g., less than about 9, and often less than about 8) that is suitable for disposal in biological treatment facilities, without prior, supplemental neutralization steps.

Embodiments of the invention are directed to methods, and preferably continuous methods, for treating a gas stream comprising an acid gas such as hydrogen chloride (HCl) using both primary and secondary neutralization zones or scrubbers. A first portion of the gas stream is contacted with a feed neutralization solution (e.g., an aqueous hydroxide solution) in the primary neutralization zone. The feed neutralization solution may be entirely a makeup neutralization solution, if the primary neutralization zone is operated with once-through liquid flow. Often, however, the feed neutralization solution is a combination of both a makeup neutralization solution having a relatively high concentration of a basic component (e.g., sodium hydroxide) and a recycled portion of partially consumed neutralization solution having a relatively low concentration of the basic component and exiting the primary neutralization zone. In many cases, liquid recycle operation (i.e., recycling at least a portion of the partially consumed neutralization solution to the primary neutralization zone) allows for greater liquid mass flow (flux) across the vapor-liquid contacting stage(s) of the primary neutralization zone to improve liquid distribution, contacting with vapor, and overall utilization.

A second portion of the gas stream is contacted, in the secondary neutralization zone or scrubber, with all or at least a portion (e.g., a non-recycled portion) of the partially consumed neutralization solution from the primary neutralization zone. Importantly, the performance of the secondary neutralization zone serves as a basis for regulating or controlling the flow of the second portion of the gas stream to this zone. This performance may be characterized in terms of the degree of consumption of the partially consumed neutralization solution in the secondary neutralization zone. For example, a representative degree of consumption, as a consumption set point or basis for controlling the flow of the second portion of the gas stream to the secondary neutralization zone, may be at least about 95% (e.g., in the range from about 95% to about 99%) of complete consumption of the partially consumed neutralization solution. Complete consumption is marked by the titration end point, for example, at which 0% concentration of the basic component and neutral pH and of the solution are achieved.

Therefore, the degree of consumption may be determined by analysis, preferably continuously using an on-line analyzer, of the concentration (i.e., of the basic component such as sodium hydroxide) or pH of the secondary zone solution effluent, for example, within the secondary neutralization zone, or preferably after exiting this zone. Exemplary analyzers continuously measure a combination of neutralization solution properties including conductivity, sonic velocity, density, viscosity, etc. to determine concentration and/or pH. The LiquiSonic™ on-line analyzers (e.g., LiquiSonic 40™) from SensoTech GmbH (Magdeburg-Barleben, Germany), for example, provide this information through measurement of both conductivity and sonic velocity.

A suitable pH set point for controlling gas flow to the secondary neutralization zone is within a range from about 4 to about 12, (e.g., a pH set point of 4, 5, 6, 7, 8, 9, 10, 11, or 12 or a fractional pH value in this range), normally from about 5 to about 10, and often from about 6 to about 8. Depending on the average flow rate and acid gas concentration of the second portion of the gas stream to the secondary neutralization zone, relative to the neutralization capacity of this zone (e.g., based on the partially consumed neutralization solution flow rate and concentration entering this zone, as well as the reservoir or standing level volume), it may be preferable to operate at a near neutral pH, although in some cases the pH may be more practically controlled at a point on the “flatter” portion of the titration curve. For example, controlling the degree of consumption, in the secondary neutralization zone, of a 4% by weight, partially consumed NaOH solution to 99% of complete consumption would correspond to controlling the pH of the secondary neutralization zone effluent with a pH set point of 12 (corresponding to a reduction in NaOH concentration from 4% by weight, at pH=14, to 0.04% by weight, at pH=12). A representative concentration set point for the secondary zone solution effluent is generally in the range from about 0% to about 1%, typically in the range from about 0% to about 0.5%, and often in the range from about 0% to about 0.1%, by weight.

Further embodiments of the invention are directed to methods as described above, in which a gas effluent from the secondary neutralization zone (i.e., a secondary zone gas effluent) is contacted, together with the first portion of the gas stream comprising the acid gas, in the primary neutralization zone. The secondary zone gas effluent may therefore be mixed with the first portion of the gas stream, prior to entering the primary neutralization zone, or these gas streams may alternatively be introduced separately into this zone, for example, at different axial heights of a packed, vertical scrubber column depending on the relative acid gas concentrations in these gas streams.

Normally, vapor-liquid contacting in both the primary and the secondary neutralization zones is carried out with countercurrent flows (i.e., downward liquid flow and upward gas flow), but it is recognized that a gas stream entering a neutralization zone could also be bubbled through a reservoir or standing level of neutralization solution, for example maintained using a level control loop. In other representative embodiments, the primary neutralization zone comprises a greater number of vapor-liquid contacting stages than the secondary neutralization zone, such that the latter zone acts as a final, incremental treatment zone that uses a minor portion of the gas stream to be treated to effect complete or nearly complete neutralization of the secondary zone solution effluent, as an effluent of the process. This minor portion may, for example, represent less than about 40% (e.g., in the range from about 5% to about 35%) or less than about 30% (e.g., in the range from about 10% to about 25%) of the flow of the gas stream treated according to methods described herein.

In a specific embodiment, the primary neutralization zone comprises a plurality of vapor-liquid contacting stages, while the secondary neutralization zone comprises only a single vapor-liquid contacting stage. Regardless of the number of stages used in each zone, vapor-liquid contacting in the primary neutralization zone, and possibly also in the secondary neutralization zone, may be facilitated using internal contacting devices known to improve contacting efficiency (i.e., reduce the height equivalent of a theoretical plate (HETP) or equilibrium contacting stage), such as suitable column packing or trays (e.g., having liquid downcomers and/or vapor risers) of a material suitable for the environment of the neutralization zone(s). Other conventional equipment that may benefit the operation of the primary and/or secondary neutralization zones includes, for example, inlet vapor and/or inlet liquid distributors and/or gas outlet demisters.

Further exemplary embodiments of the invention are directed to acid gas-containing gas stream treatment methods as described above, in which the acid gas is hydrogen chloride and the gas stream is an effluent from a catalytic hydrocarbon conversion process utilizing a chlorided catalyst. Representative processes are those used in refinery operations for the isomerization of paraffins, as discussed above. For example, one type of isomerization process provides nearly equilibrium conversion of n-butane in a hydrocarbon feedstock to isobutane, which can be used in the downstream alkylation of light olefinic hydrocarbons (e.g., butenes) to provide a high octane motor fuel component or otherwise dehydrogenated to produce isobutylene, either as a monomer in plastics manufacturing or for the synthesis of methyl tertiary butyl ether (MTBE) in gasoline blending.

In an n-butane isomerization processes, the hydrocarbon feedstock comprising n-butane is reacted in the presence of a platinum-containing, chlorided alumina catalyst under butane isomerization conditions that include an isomerization reaction zone temperature in a representative range from about 120° C. (250° F.) to about 225° C. (437° F.) and a gauge pressure generally in the range from about 7 barg (100 psig) to about 70 barg (1000 psig). The isomerization reaction zone may comprise a single reactor, but often comprises two reactors in series. The liquid hourly space velocity (LHSV) is typically from about 0.5 hr⁻¹ to about 20 hr⁻¹, and often from about 1 hr⁻¹ and about 4 hr⁻¹). The LHSV, closely related to the inverse of the reactor residence time, is the volumetric liquid flow rate over the catalyst bed divided by the bed volume and represents the equivalent number of catalyst bed volumes of liquid processed per hour. A representative hydrogen to hydrocarbon molar ratio (H₂/HC) in the butane isomerization reaction zone is from about 0.01 to about 0.05, and this ratio is normally maintained, advantageously, without the need for recycling hydrogen-containing gas. A chloride promoter or chloriding agent is added to the isomerization reaction zone to maintain a catalyst chloride level generally in the range from about 30 to about 300 parts per million (ppm) by weight.

In a normal C₅/C₆ paraffin isomerization process, a hydrocarbon feedstock, such as a straight-run naphtha fraction obtained from crude oil distillation, comprising predominantly n-pentane and n-hexane, is reacted in the presence of a platinum-containing, chlorided alumina catalyst under isomerization conditions as discussed above with respect to the isomerization of n-butane, except for the preferred use of relatively lower isomerization reaction zone temperatures, for example in range from about 104° C. (220° F.) to about 225° C. (437° F.). The H₂/HC ratio and catalyst chloride level are also generally within the ranges given above with respect to n-butane isomerization. As discussed, the use of the chloriding agent in the isomerization reaction zone generates hydrogen chloride that must eventually be removed from one or more process effluent streams.

Typically, the gas streams containing hydrogen chloride, which are of most significance in the treatment methods described herein, are the overhead vapors from fractionation columns, such as reactor effluent stabilizers used to separate hydrogen and light hydrocarbon byproducts (e.g., cracked byproducts such as methane, ethane, and propane) from an isomerate product downstream of the isomerization reaction zone.

Other embodiments of the invention are therefore directed to processes for converting hydrocarbons and particularly for isomerizing normal paraffins. Exemplary processes comprise reacting a hydrocarbon feedstock, for example comprising predominantly n-butane, or predominantly a mixture of n-pentane and n-hexane, under the isomerization conditions and in the manner discussed above, to provide an isomerate, for example comprising isobutane or a mixture of isopentane and isohexane (e.g., as any of the C₅ or C₆ branched-chain isomers such as 2,2-dimethyl butane). The addition of a chloriding agent to the isomerization reaction zone to maintain a catalyst chloride level generates a gas stream comprising hydrogen chloride. The processes further comprise treating the gas stream according to any of the methods described above.

Yet further embodiments of the invention are directed to acid gas neutralization systems or apparatuses for performing any of the methods for treating gas streams comprising an acid gas, as described above. Representative systems comprise primary and secondary scrubbers. The primary scrubber has a gas inlet for receiving a first portion of the gas stream and the secondary scrubber has a gas inlet for receiving a second portion of the gas stream. The systems further comprise a flow control loop for controlling the second portion of the gas stream in response to a degree of consumption, in the secondary scrubber, of the partially consumed neutralization solution exiting the primary scrubber. Further features of the systems include those of the methods and hydrocarbon conversion processes described above. For example, the secondary scrubber may further comprise, in an upper section, a gas outlet in fluid communication with the gas inlet of the primary scrubber, in a lower section. This allows contacting, in the primary scrubber, of a secondary scrubber gas effluent together with the first portion of the gas stream, with a feed neutralization solution. A liquid inlet in the primary scrubber, in an upper section, receives the feed neutralization solution.

In a preferred embodiment, the secondary scrubber, which often contains a neutralization solution that is at least partially consumed if not completely consumed, comprises a more highly corrosion resistant material (e.g., in acidic environments that may arise) than the primary scrubber. Representative materials of the secondary scrubber include nickel alloys such as Monel™, Hastelloy™, and others. Certain plastics and glass may also be used in specific (e.g., low pressure) applications.

These and other embodiments and aspects of the invention are apparent from the following Detailed Description.

### BRIEF DESCRIPTION OF THE DRAWING

FIG. 1 schematically illustrates a process according to a representative embodiment of the invention.

FIG. 1 is to be understood to present an illustration of the invention and/or principles involved. Some items not essential to the understanding of the invention are not shown. As is readily apparent to one of skill in the art having knowledge of the present disclosure, gas treatment methods and apparatuses according to various other embodiments of the invention, will have other configurations and components that are determined, in part, by their specific use.

### DETAILED DESCRIPTION

As discussed above, the present invention is associated with the treatment, preferably in a continuous manner, of gas streams comprising one or more acid gases. Acid gases refer to compounds in the gaseous state that form acids in the presence of water at neutral pH. Hydrogen chloride gas, for example, readily forms hydrochloric acid in the presence of moisture. Other representative acid gases of interest include hydrogen sulfide (H₂S), sulfur dioxide (SO₂), sulfur trioxide (SO₃) and chlorine (Cl₂). Concentrations of the acid gas, or combination of acid gases, in the gas stream to be treated are in a range generally from about 100 parts per million (ppm) to about 2%, typically from about 500 ppm to about 1%, and often from about 1000 ppm to about 5000 ppm, by volume. These concentrations are representative of the hydrogen chloride content in gas streams from hydrocarbon conversion processes, and particularly those utilizing a chlorided catalyst, as discussed above. Such gas streams more specifically include overhead vapors from distillation columns (e.g., stabilizers) used to separate a low boiling fraction from the isomerization reaction zone effluent.

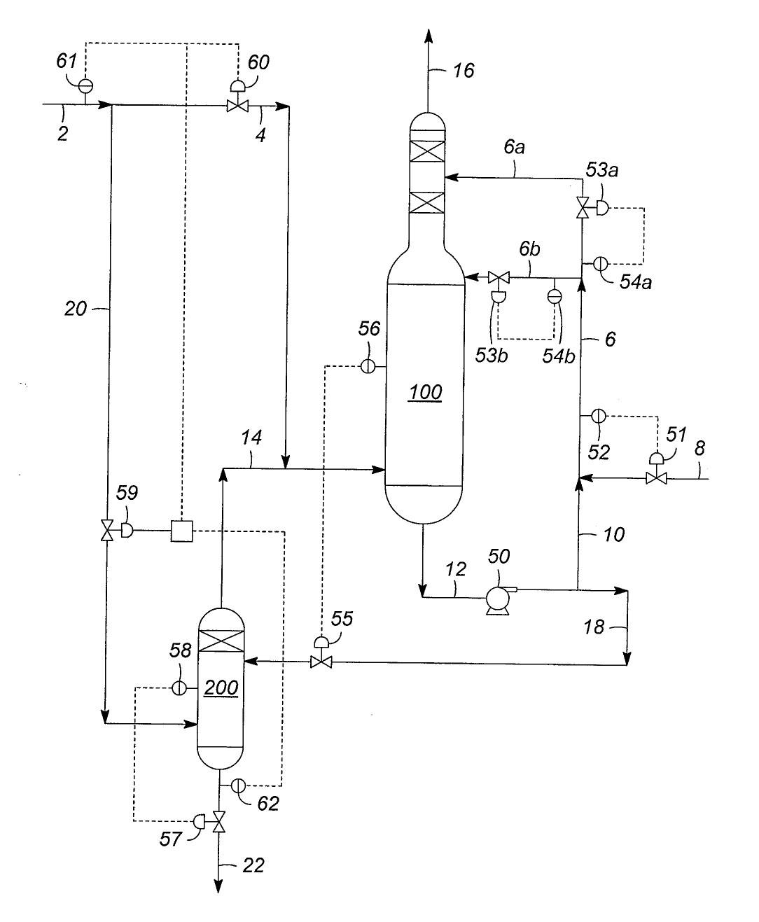

FIG. 1 is a flow scheme illustrating a representative, continuous acid gas removal method of the invention, in which neutralization solution is utilized efficiently. A representative neutralization solution is aqueous sodium hydroxide or caustic solution, but it will be appreciated that any other basic neutralization solution may be used. For example, hydroxide solutions in general are applicable, and these include alkali and alkaline earth metal hydroxides (e.g., potassium hydroxide and calcium hydroxide), in addition to ammonium hydroxide and its organoammonium hydroxide derivatives, and others. A hydroxide solution, which may comprise any hydroxide or mixture of hydroxides, is used for exemplary purposes in describing the embodiment of FIG. 1, without limiting the invention.

As shown in FIG. 1, gas stream 2 comprising an acid gas (e.g., hydrogen chloride) at a concentration as described above is split into two portions. First portion 4, which may be combined with secondary zone gas effluent 14, is passed to primary scrubber 100 where it is contacted with feed hydroxide solution 6 that is a combination of makeup hydroxide solution 8 and recycled portion 10 of partially consumed hydroxide solution 12 exiting primary scrubber 100 after scrubbing first portion 4 of gas stream 2. Recycle pump 50 is used to maintain the circulation of hydroxide solution in primary scrubber 100. Makeup hydroxide solution flow control valve 51 maintains the flow of makeup hydroxide solution 8 according to the concentration (e.g., of sodium hydroxide) of feed hydroxide solution 6, measured by hydroxide concentration analyzer 52. Representative concentrations of makeup hydroxide solution 8 are generally in the range from about 3% to about 14%, typically from about 3% to about 12%, and often from about 8% to about 12%, by weight. Separate portions 6a, 6b of feed hydroxide solution may be routed to different sections (e.g., upper and middle sections, respectively) of primary scrubber 100. These separate sections may each have packing, trays, or other contacting devices that provide one or a plurality of vapor-liquid equilibrium contacting stages. The flows of these portions may be controlled by control valves 53a, 53b according to outputs from flow meters 54a, 54b.

Primary scrubber 100 therefore provides both treated gas stream 16 and partially consumed hydroxide solution 12. The concentration of acid gas in treated gas stream 16, relative to that in gas stream 2 is generally reduced by at least about 95%, and often by at least about 99%. The concentration of acid gas (e.g., hydrogen chloride) in treated gas stream 16 is generally less than about 100 ppm, typically less than about 10 ppm, and often less than about 1 ppm, by volume. A high degree of acid gas removal efficiency is therefore normally achieved, especially as the concentration of partially consumed hydroxide solution 12 (and consequently the driving force for acid gas removal) is increased. Representative concentrations of partially consumed hydroxide solution 12 are generally in the range from about 1% to about 6%, and often from about 2% to about 4%, by weight. Partially consumed hydroxide solution 12, normally after having removed a substantial portion of the acid gas entering with gas stream 2, is therefore generally a highly alkaline solution requiring supplemental neutralization prior to disposal (e.g., in a biological treatment facility).

According to embodiments of the invention, however, at least a portion of partially consumed hydroxide solution 12, for example non-recycled portion 18 as shown in FIG. 1, is contacted in secondary scrubber 200 with second portion 20 of gas stream 2, to carry out more complete consumption the hydroxide solution. Primary scrubber level control valve 55 regulates the flow of non-recycled portion 18 of partially consumed hydroxide solution 12 that is removed from primary scrubber 100 and fed to secondary scrubber 200. The liquid level in primary scrubber 100, as measured by primary scrubber level indicator 56, therefore controls the liquid flow through primary scrubber control valve 55.

Secondary scrubber 200 provides secondary zone gas effluent 14, which is often sent to primary scrubber 100, separately or in combination with first portion 4 of gas stream 2, to provide more thorough acid gas scrubbing. Spent hydroxide solution 22 exits secondary scrubber 200, as regulated by spent hydroxide level control valve 57, which is governed by the liquid level in secondary scrubber 200, measured with secondary scrubber level indicator 58.

As discussed above, the degree of consumption in secondary scrubber 200, of partially consumed hydroxide solution entering this scrubber, namely the non-recycled portion 18, is used as a basis for control of second portion 20 of gas stream 2 through secondary scrubber gas inlet flow control valve 59. According to the embodiment shown in FIG. 1, this control valve 59 can cooperate with primary scrubber gas inlet flow control valve 60 to maintain an upstream pressure in gas stream 2, as measured by pressure indicator 61. However, secondary scrubber gas inlet flow control valve 59 is also governed under normal operating conditions by the hydroxide concentration or pH of spent hydroxide solution 22, corresponding to a degree of consumption of non-recycled portion 18 of partially consumed hydroxide solution 12 in secondary scrubber 200. This concentration or pH is measured, preferably continuously, by spent hydroxide solution analyzer 62.

The overall gas treatment method therefore utilizes the second portion 20 or slip stream of gas stream 2 to continuously treat the net effluent, corresponding to non-recycled portion 18 of the partially consumed hydroxide solution 12, from primary scrubber 100. As discussed above, the system is usually designed such that this slip stream represents only a minor portion of gas stream 2 to be treated, but still a sufficient portion to carry out complete or nearly complete neutralization and thereby provide a spent hydroxide solution 22 that, advantageously, is non-hazardous and meets pH specifications (e.g., having a pH of about 9 or less) for direct biological treatment.

Aspects of the present invention are therefore directed to treatment methods utilizing at least a primary and a secondary scrubber (or a primary and a secondary neutralization zone) to continuously treat separate portions of an acid gas-containing gas stream. Those having skill in the art, with the knowledge gained from the present disclosure, will recognize that various changes can be made in these methods, including the use of additional scrubbers or neutralization zones and/or the addition of further process streams (e.g., a makeup neutralization solution to the secondary scrubber) without departing from the scope of the present disclosure. The subject matter described herein is therefore representative of the present invention and its associated advantages and is not to be construed as limiting the scope of the invention as set forth in the appended claims.

1. A method for treating a gas stream comprising an acid gas, the method comprising:
(a) contacting a first portion of the gas stream with a feed neutralization solution in a primary neutralization zone to provide a treated gas stream and a partially consumed neutralization solution; and
(b) contacting a second portion of the gas stream with at least a potion of the partially consumed neutralization solution in a secondary neutralization zone to provide a secondary zone solution effluent;
wherein a degree of consumption of the partially consumed neutralization solution in the secondary neutralization zone controls a flow of the second portion of the gas stream.

2. The method of claim 1, wherein the degree of consumption is at least about 95% and a consumption set point representing the degree of consumption controls the flow of the second portion of the gas stream.

3. The method of claim 1, further comprising determining the degree of consumption by analysis of a concentration or a pH of the secondary zone solution effluent.

4. The method of claim 3, wherein the flow of the second portion of the gas stream is controlled by a pH set point from about 4 to about 10 or a concentration set point from about 0% to about 0.5% by weight.

5. The method of claim 1, wherein the neutralization solution is a hydroxide solution.

6. The method of claim 1, wherein the acid gas is selected from the group consisting of hydrogen chloride, hydrogen sulfide, sulfur dioxide, and chlorine.

7. The method of claim 1, wherein the acid gas is hydrogen chloride and the gas stream is an effluent from a catalytic hydrocarbon conversion process utilizing a chlorided catalyst.

8. The method of claim 1, wherein step (b) provides a secondary zone gas effluent.

9. The method of claim 8, further comprising contacting the secondary zone gas effluent, together with the first portion of the gas stream, with the feed neutralization solution in the primary neutralization zone.

10. The method of claim 1, further comprising recycling at least a portion of the partially consumed neutralization solution to the primary neutralization zone.

11. The method of claim 1, wherein the primary neutralization zone comprises a greater number of vapor-liquid contacting stages that the secondary neutralization zone.

12. A continuous acid gas removal method having efficient neutralization solution utilization, the method comprising:
(a) contacting, in a primary neutralization zone, a first portion of a gas stream comprising an acid gas selected from the group consisting of hydrogen chloride, hydrogen sulfide, sulfur dioxide, and chlorine with a feed hydroxide solution to provide a treated gas stream and a partially consumed hydroxide solution; and
(b) contacting, in a secondary neutralization zone, a second portion of the gas stream with at least a portion of the partially consumed hydroxide solution to provide a spent hydroxide solution and a secondary zone gas effluent; and
(c) passing the secondary neutralization zone gas effluent to the primary neutralization zone,
wherein a degree of consumption of the partially consumed hydroxide solution in the secondary neutralization zone controls a flow of the second portion of the gas stream.

13. The method of claim 12, wherein the portion of the partially consumed hydroxide solution that is contacted in step (b) is a non-recycled portion, and wherein the feed hydroxide solution comprises a recycled portion of the partially consumed hydroxide solution and a makeup hydroxide solution.

14. The method of claim 13, wherein the partially consumed hydroxide solution has a hydroxide concentration from about 1% to about 6% by weight.

15. The method of claim 14, wherein the makeup hydroxide solution has a hydroxide concentration from about 3% to about 12% by weight.

16. The method of claim 15, wherein the hydroxide concentration of the feed hydroxide solution controls the flow of the makeup hydroxide solution.

17. The method of claim 12, wherein the acid gas is hydrogen chloride and the feed hydroxide solution is a sodium hydroxide solution.

18. An acid gas neutralization system comprising:
(a) primary and secondary scrubbers, the primary scrubber having a gas inlet for receiving a first portion of a gas stream comprising an acid gas and the secondary scrubber having a gas inlet for receiving a second portion of the gas steam, and
(b) a flow control loop for controlling the second portion of the gas stream in response to a degree of consumption, in the secondary scrubber, of partially consumed neutralization solution exiting the primary scrubber.

19. The system of claim 18, wherein the primary scrubber comprises a plurality of vapor-liquid contacting stages and the secondary scrubber comprises a single vapor-liquid contacting stage.

20. The system of claim 19, wherein the secondary scrubber comprises a more highly corrosion resistant material than the primary scrubber.
